(19) United States
(12) Patent Application Publication
(10) Pub. No.: US 2019/0139098 A1
(43) Pub. Date: May 9, 2019

(54) SYSTEMS AND METHODS FOR REAL-TIME DATA PROCESSING ANALYTICS ENGINE WITH ARTIFICIAL INTELLIGENCE FOR TRANSACTION HANDLING

(71) Applicant: ADNOMUS, INC., San Jose, CA (US)

(72) Inventor: Christos Margiolas, San Jose, CA (US)

(21) Appl. No.: 15/994,822

(22) Filed: May 31, 2018

Related U.S. Application Data
(60) Provisional application No. 62/513,148, filed on May 31, 2017.

(51) Int. Cl. G06Q 30/02; G06N 20/00

(52) U.S. Cl. CPC G06Q 30/0275; G06N 20/00

(57) ABSTRACT

Example implementations are directed to systems and methods to select content to publish that include receiving bids for content submissions for a publication opportunity; analyze each of the content submissions to determine a quality classification and contextual data; apply machine learning to generate a suitability score for each content submission; and select a content submission for the publication opportunity based on the on the bids, quality classification, and suitability score for the set of content submissions in view of a selection policy. According to an example implementation, content of the selected content submission is provided to publish.

This application claims priority under 35 USC 119 based on U.S. Provisional Patent Application No. 62/513,148, filed on May 31, 2017, the contents of which is incorporated herein in its entirety by reference.

### TECHNICAL FIELD

The embodiments described herein are related to data analytics and more specifically to transaction handling using artificial intelligence.

### ART

People spend more time on-line interacting with social media, online shopping, messaging, sharing content, reading, etc. that results in attention to digital content. Publishers generally provide premium content, may distribute user generated content, and typically include third-party supplemental content, such as advertisements. In related art, third-party supplemental content is distributed based on a pricing model or auction services that use periodic metrics and proprietary bidding systems.

Publishers traditionally integrate with different exchange platforms to increase the likelihood of engaging a user. However, each exchange platform has specific requirements and is generally not compatible with other exchange platforms. Thus, publishers are forced to spend large amounts of time and resources to integrate on each platform separately contributing to bottlenecks and delays. Diversification of exchange platforms increases publisher overhead through on-boarding costs and requires additional processing time thereby losing valuable opportunities to engage users.

Multiple application areas in finance, information technology, and marketing involves real time auctioning where a seller provides an offer to publish with a physical or digital resource and third-party entities, the bidders, evaluate the offer and submit a bid to either acquire or use the resource for some defined agreement (e.g., a time window).

Related art auction approaches are usually completed under a transactional scheme in few hundred milliseconds where both the seller and the bidders perform their private analysis in order to optimize their selling and purchasing strategies, respectively. A typical application scenario for online advertising involves a website or mobile application publisher (the seller) offering a access to publish on a portion of the website page(s) or application content to advertisers (bidders), where the advertisers that win the auction place advertisements.

For publishers that service a targeted audience, conventional approaches to select supplemental content rely on ineffective heuristics and slowly updated in-market segments that lead to poor user experiences and disengagement with the publisher. For publishers to be more selective of the types or quality of advertisements presented to their audience, conventional approaches are typically more costly and burdensome to implement. For delivery of relevant supplemental content, publishers need to serve targeted content based on real-time analysis.

### BRIEF DESCRIPTION OF THE DRAWINGS

Features, aspects, and embodiments are described in conjunction with the attached drawings, in which:

FIG. 1 illustrates an overview of a system in accordance with an example implementation.

FIG. 2 illustrates an example content transaction engine in accordance with an example implementation.

FIG. 3 illustrates a flow diagram of an example sequence in accordance with an example implementation.

FIGS. 4A-B illustrate example transaction sequences for resource offering in accordance with example implementations.

FIG. 5 illustrates an example content submission processing in accordance with an example implementation. It analyzes content/media attributes of each bid and provides a quality score and also determines if it safe

FIG. 6 illustrates an example relevancy scoring process for a transaction in accordance with an example implementation.

FIG. 7 illustrates an example content selection process for a transaction in accordance with an example implementation. We optimize in multiple directions and we perform a multi-objective optimization. This figure shows how we select the optimal bid based on the diverse and maybe conflicting optimization criteria.

FIGS. 8A-B illustrate example implementations for optimizing resource offerings and content submissions in accordance with example implementations. FIG. 8A illustrates how the publisher offerings are optimized to make the offerings more efficient (i.e. lucrative) to the bidders while maintaining and dynamically updating profiles for the bidders. FIG. 8B illustrate how a particular bidder offer can be boosted/altered to optimize particular interests without breaking the Analytics and machine-learning models.

FIG. 9 illustrates an example server computing environment with an example computer device suitable for use in example implementations.

FIG. 10 illustrates an example networking environment with example computer devices suitable for use in example implementations.

FIG. 11 illustrates a block diagram of an example computing device or system that may be used in connection with various example implementations described herein.

FIG. 12 illustrates an example analytics flow diagram in accordance with an example implementation.

### DETAILED DESCRIPTION

The following detailed description provides further details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or operator control over certain aspects of the implementation, depending on the desired implementation of one of ordinary skill in the art practicing implementations of the present application.

An example aspect facilitates a content transaction service to select content to publish from a multiple content submissions that is suitable for a specific publication or distribution opportunity. Analysis of attributes of the content submissions is used to assign quality metrics and determine relevant contexts. Machine learning techniques are applied to the results of the analysis along with profile information of the submitters to generate a suitability score of the content submissions for the targeted publication or distribution opportunity.

A seller in an online transaction may wish to optimize the return of revenue from, for example, an auction while also selling the resource to a bidder that aligns with the seller's operation interests. Each bidder usually bids for offers that serve the bidder's interests while minimizing the cost to win each auction.

Example implementations are directed to systems and methods to select content to publish that include receiving bids for content submissions for a publication opportunity; analyze each of the content submissions to determine a quality classification and contextual data; apply machine learning to generate a suitability score for each content submission; and select a content submission for the publication opportunity based on the on the bids, quality classification, and suitability score for the set of content submissions in view of a selection policy. According to an example implementation, content of the selected content submission is provided to publish.

Accordingly, example implementations of the methods and systems associated with the present disclosure are directed to analyzing information associated with potential third-party content to apply machine learning models to the characterize content and provide a highly relevant supplemental content to be published to an audience to increase user engagement. An example aspect facilitates a content transaction service that is compatible to be applied to multiple different environments. For example, the content transaction service, as described herein, can be used for renting cloud resources to different customers (bidders).

Multiple application areas in computing systems and Information Technology services depend on real-time analysis of content provided either by users and/or third parties. The content is typically received as text, speech, image and video forms. An aspect of the present disclosure describes real-time analysis on the contextual and quality reasoning of given content. An example aspect of the disclosure described herein includes real-time requirement and multi-dimensional factors that create large resource savings and new functionality for third-party content producers and publishers. As described herein, the methods and systems receive input from multiple content providers and are backwards-compatible across existing legacy platforms to create protocols for easy and efficient platform integration and cross platform harmonization.

In some example implementations, an infrastructure independent transaction service is provided to deploy optimized matching between supplemental content from third-party providers and audiences or publication policies of publishers or distributors. The transaction service provides efficient automated processes to select content that align with publisher goals and audiences' interests while adjusting for market based factors to optimize long-term profitability between the parties. By publishing the suitable supplemental content, publishers can increase user engagement with publisher or primary content and grow their audience penetration. By using analytics driven bidding options, content providers develop an affinity with a publisher and increase the probability of user engagement with the supplemental content for publication opportunities.

An example implementation includes determining a set of content submissions that satisfy specifications for a publication opportunity in view of quality classification and contextual data analysis. The analysis results can be used for applying machine learning to generate a suitability score for each content submission in view of specifications for the publication opportunity.

The transaction service can select supplemental content that satisfies the publisher's specifications and recommend updated supplemental content that aligns with a target audience of the publisher. The updated supplemental content selected using the transaction service improves user experiences, increases user engagement, optimizes market opportunities, and reduces resource constraints. The term “real-time analysis” denotes the requirement of performing the content analysis and recommendation in a short time window, which is typically at most few milliseconds. This requirement is typically imposed by the characteristics of digital content delivery.

Furthermore, present disclosure includes modules to protect against malicious content being distributed. Supplemental content is targeted with a precise understanding of the content without jeopardizing publisher and/or user. According to an example implementation of the present disclosure, a content transaction system can be integrated with products such as online advertising, smart agents and service recommendation systems. For example, the content transaction system can integrate with the existing advertising ecosystem where programmatic ad exchange takes place.

For example, the transaction service can be used by content providers (e.g., advertisers) to bid on-the-fly or via an optioning system to place supplemental content (e.g., advertisements) with a publication opportunity, for example, publish on a website or in an application. This procedure takes place in few hundred milliseconds and it is typically driven by simple heuristics and various forms of off-line analytics. The transaction system facilitates suitable content to be negotiated and placed using on-line analysis for content-aware supplemental content targeting and in order to protect against prohibitive overheads and latencies to perform the analytics in less than 1 ms.

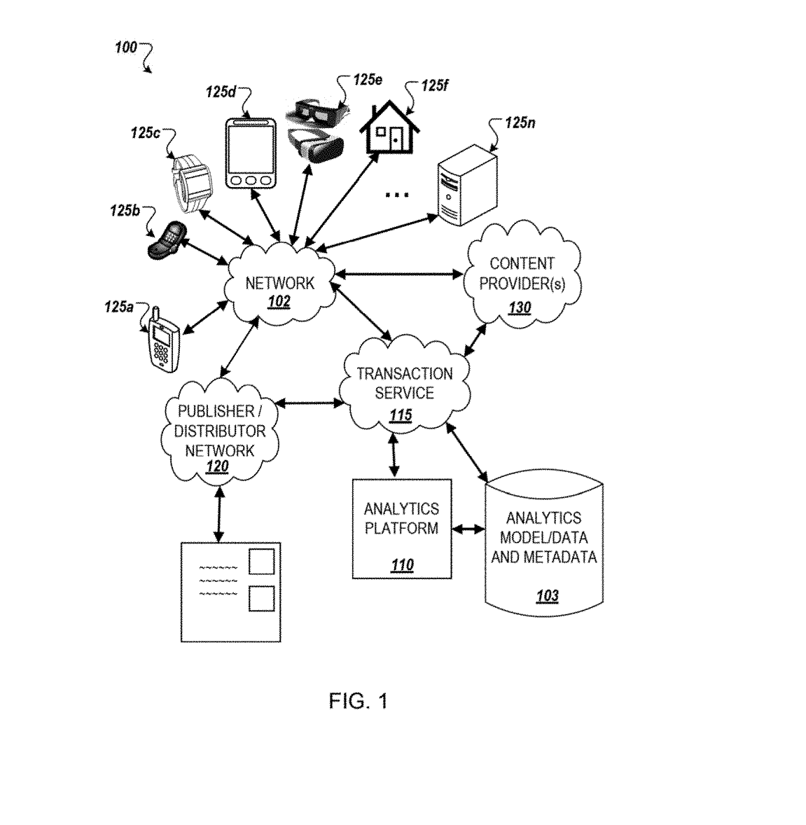

FIG. 1 illustrates an overview of a system 100 in accordance with an example implementation. The system 100 includes an analytics platform 110 configured to provide content transaction services 115 to one or more publisher networks 120.

A publisher network 120 can communicate with one or more client devices 125a-125n to provide content and/or supplemental. In accordance with embodiments described herein, the analytics platform 110 can identify supplemental content for the publisher network 120 to deliver to client devices 125a-125n.

The analytics platform 110 may be implemented in the form of software (e.g., instructions on a non-transitory computer readable medium) running on one or more processing devices, such as the one or more client, as a transaction service 115, remotely via a network 102, connected to publisher network(s) 120 and content providers 130 or other configuration known to one of ordinary skill in the art.

The terms “computer”, “computer platform”, processing device, and client device are intended to include any data processing device, such as a desktop computer, a laptop computer, a tablet computer, a mainframe computer, a server, a handheld device, a digital signal processor (DSP), an embedded processor, or any other device able to process data. The computer/computer platform is configured to include one or more microprocessors communicatively connected to one or more non-transitory computer-readable media and one or more networks.

The analytics platform 110 directly or indirectly includes memory such as Analytics Model/Data and Metadata 103 (e.g., RAM, ROM, and/or internal storage, magnetic, optical, solid state storage, and/or organic), any of which can be coupled on a communication mechanism (or bus) for communicating information.

In an example implementation, the analytics platform 110 can be host a transaction service 115 as a cloud service and communicatively connected via a network to receive user generated content.

The term “communicatively connected” is intended to include any type of connection, wired or wireless, in which data may be communicated. The term “communicatively connected” is intended to include, but not limited to, a connection between devices and/or programs within a single computer or between devices and/or separate computers over the network 102. The term “network” is intended to include, but not limited to, packet-switched networks such as local area network (LAN), wide area network (WAN), TCP/IP, (the Internet), and can use various means of transmission, such as, but not limited to, WiFi®, Bluetooth®, Zigbee®, Internet Protocol version 6 over Low-power Wireless Area Networks (6LowPAN), power line communication (PLC), Ethernet (e.g., 10 Megabyte (Mb), 100 Mb and/or 1 Gigabyte (Gb) Ethernet) or other communication protocols.

Publisher network 120 transacts with the content providers 130 via the transaction service 115. The publisher network 120 interacts with third-party content providers 130 to receive supplemental content to include with services provided to users. The transaction service 115 provides functionality for publishers from different networks, formats, communication channels, etc. to offer publication opportunities with content providers 130.

Content providers 130 can respond to publication opportunities with bids, terms, requests for accommodations, etc. to provide developed supplemental content (e.g., advertisements, services, etc.). In an example implementation, the transaction service 115 employs artificial intelligence to adaptively link publication opportunities with content providers based on a set of primary factors (e.g., a minimum payment price, content medium, content safety and security, etc.), and one or more sets of secondary factors (formatting, audience size, runtime, message coordination, target audience, affinity matching, etc.). The transaction service 115 tracks participating publishers and content providers 130 to determine heuristics that improve the probability of repeated interactions that help each participant grow their business interest. For example, based on a content provider's profile, the transaction service 115 observes bidding patters, content quality ratings, content placement ratings, etc. to locate publication opportunities with an audience that is receptive to the content. Based on a publisher's profile and specifications, the transaction service 115 can locate content from content providers that is positive experience for the publisher's audience.

The transaction service 115 enable publishers to find content that aligns with financial specifications, as well as, business, editorial, and technological specifications. The transaction service 115 employs an artificial intelligence system to gather relevant analytics to adjust the primary factors and secondary factors to negotiate for supplemental content to satisfy a publication opportunity.

Publisher network 120 can provide users with access to various types of content. For example, a publisher may host a website or mobile application to provide premium content or online services to users via the network 102. User may access the content from a client device (e.g., client device 125a-125n), remote servers (e.g., server 125X), third-party databases, or other configuration known to one of ordinary skill in the art. The publisher can publish or push content to users via different types of client devices 125a-125n. Client devices 125a-125n can include, for example, handheld digital devices 125a, mobile phones 125b, wearable technology 125c (e.g., fitness trackers, location sensors, GPS units, Bluetooth® beacons, etc.), mobile computing devices 125d (e.g., laptops, tablets, etc.), virtual and augmented reality devices 125e, computing devices 125n (e.g., desktops, mainframes, network equipment, etc.), location based systems 125f (e.g., control systems, building environment control devices, security systems, corporate infrastructure, smart environments, etc.), as well as cloud services 125g (e.g., remotely available proprietary or public computing resources).For example, the publisher network 120 can publish a website and select an advertisement to publish to the client device. For example, client devices 125a-125n can be communicatively connected to the other client device using WiFi®, Bluetooth®, Zigbee®, Internet Protocol version 6 over Low power Wireless Area Networks (6LowPAN), power line communication (PLC), Ethernet (e.g., 10 Megabyte (Mb), 100 Mb and/or 1 Gigabyte (Gb) Ethernet) or other communication protocols.

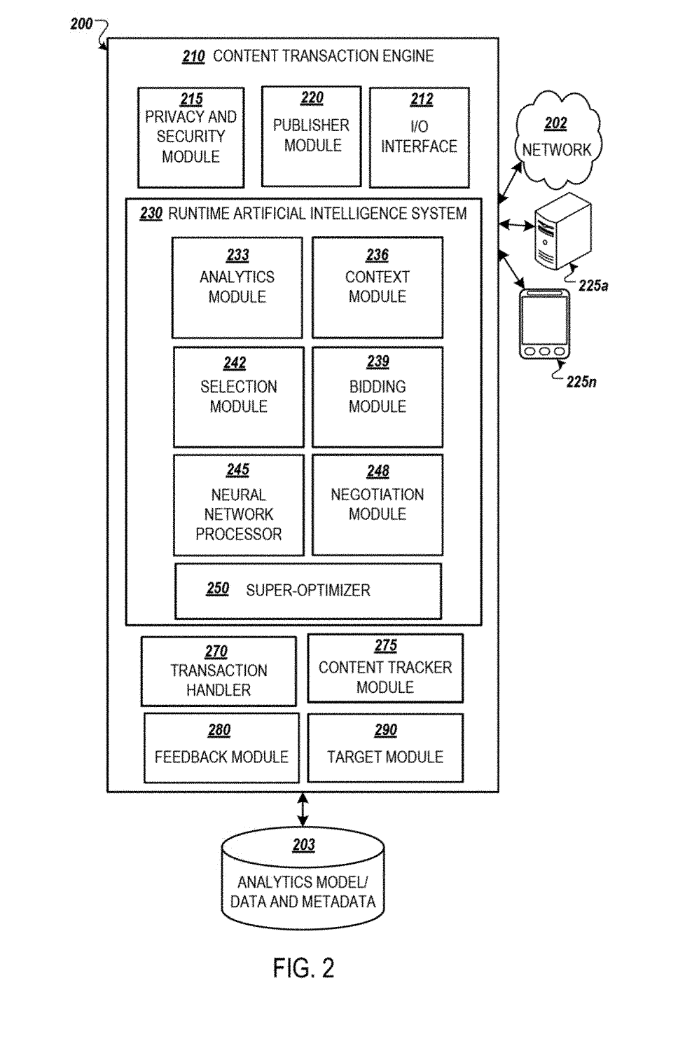

FIG. 2 illustrates an example system 200 including a content transaction engine 210 in accordance with an example implementation. The content transaction engine 210 includes one or more I/O interfaces 212, a privacy and security module 215, a publisher module 220, and a runtime artificial intelligence system 230

In an example implementation, the I/O interface 212 includes one or more communication interfaces communicatively connected with different types of client devices 225a-225n (e.g., client devices 125a-125n of FIG. 1) directly or via a network 202 in order to publish or provide content that may include supplemental content from content providers. The I/O interface 212 can receive and provide data for different types of devices 225 (e.g., client devices 125a-125n) or on-line services and communicate with content publishers.

The content transaction engine 210 receives, via the I/O interface 212, information such bid request, etc., and analyzes the information, via runtime artificial intelligence system 230, to select a bid from a content provider to publish to user.

According to an embodiment, the runtime artificial intelligence system 230 can include an analytics module 233, a context module 236, a bidding module 239, a selection module 242, a neural network processor 245, a negotiation module 248, a super optimizer 250, etc.

The analytics module 233 can deconstruct and analyze content to identify characteristics with additional information from the context module 236. The bidding module 239 can curate the publishers' strategies and the bidders' strategies, including budget, the preferred types and characteristics of sellers. For example, in online advertising, this can be the geolocation of a website and visitor, the language used, the time of day etc. The negotiation module 248 automatically manages rounds of offers and counter offers based on thresholds and priorities assigned to each strategy factor of the parites. The super optimizer 250 optimization in multiple different directions in parallel. The runtime artificial intelligence system 230 optimizes for multiple wins rather than the maximum prize. For example, the super optimizer 250 can adjust the auction to maximize Seller Revenue, maximize of Bidder Budget Efficiency, strategic Relevancy both for sellers and bidders, quality of service both for sellers and bidders, business/partnership development for sellers and bidders, etc.

The content transaction engine 210 can also include a transaction handler module 270, a content tracker module 275, a feedback module 280, and target module 290. The content transaction engine 210 is coupled to one or more Analytics Model/Data and Metadata repositories 203 for storing data (e.g., information, content, models, feedback, bidding histories, profiles, etc.).

Example implementations can include data retention and protection polices to ensure malicious content is not published and any personally identifiable user data is scrubbed from any repositories. In cases where sensitive or propriety transaction data is stored, the Analytics Model/Data and Metadata repositories 203 include data encryption and anonymization tools to restrict access or leakage of any sensitive information.

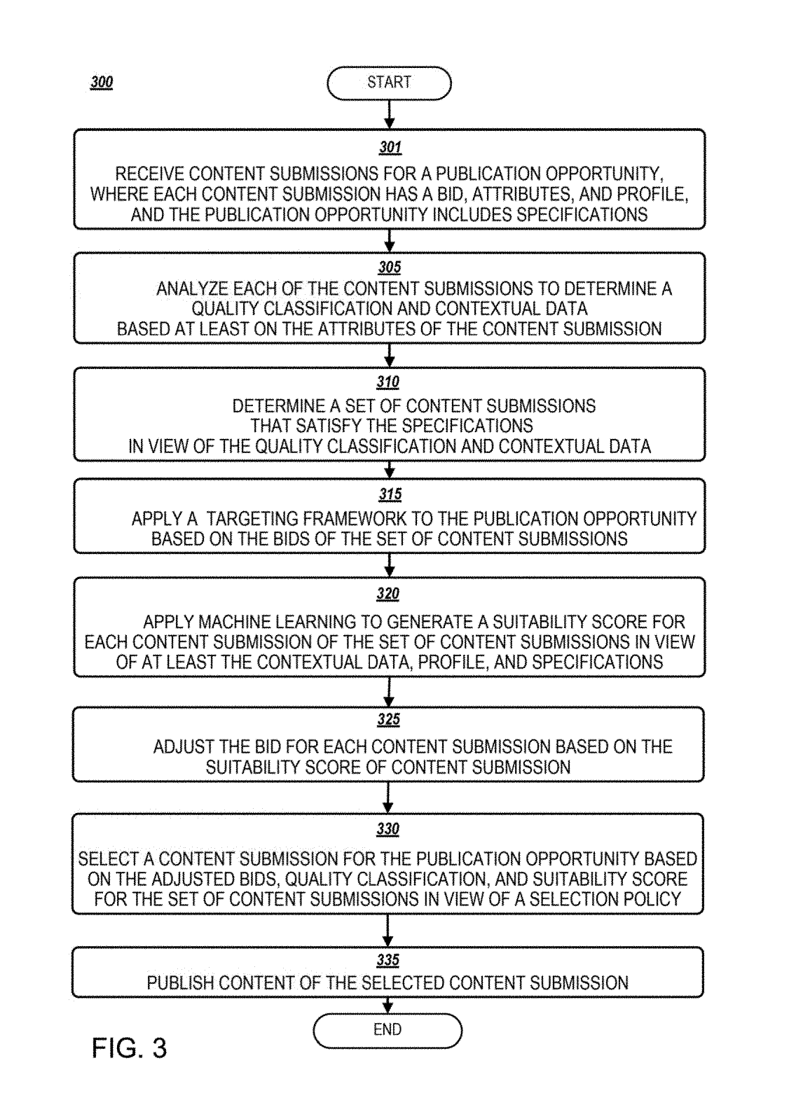

FIG. 3 illustrates a flow diagram of method 300 for a transaction service using an analytics model in accordance with an example implementation. The method 300 is performed by processing logic that may comprise hardware (circuitry, dedicated logic, etc.), software (such as operates on a general-purpose computer system or a dedicated machine), or a combination of both. Method 300 may be performed by the analytics platform 110 of FIG. 1 or Content transaction engine 210 of FIG. 2. Though method 300 is described herein as being performed by a runtime artificial intelligence system, method 300 may also be performed by other processing logic.

At 301, the processing device receives multiple content submissions for a publication opportunity. Each content submission can include a bid with one or more attributes. The party that provides the content submission can be associated with a content provider profile (CPP). A CPP can be used to track the parties past transactions, such as, bidding history, bidding patterns, etc., as well as past content data, such as, contextual patterns, quality patterns, content usage, content placement, content engagement performance, etc. Profile information of a CPP is used to track relationships with specific publishers, identify successful target audience attributes, and develop affinities for the CPP.

The publication opportunity includes specifications that can be initially set by the publisher. Specifications for the publication opportunity describe technical requirements for the content, such as formats, interactive support, etc. as well as performance guidelines, such as, quality threshold, user interaction expectations, initial bid requirements, etc.

At block 305, the processing device analyzes each of the content submissions to determine a quality classification and contextual data based at least on the attributes of the content submission.

At block 310, the processing device determines a set of content submissions that satisfy the specifications in view of the quality classification and contextual data.

At block 315, the processing device can apply a targeting framework to the publication opportunity based on the bids of the set of content submissions, wherein the specifications of the publication opportunity are adjustable.

In some example implementations, each aspect of the specifications for the publication opportunity can be adjustable. For example, a publisher can set a range, maximum, minimum, etc. value or percentage to adjust a technical requirement or performance guidelines based on the content submissions initially received. Further, the publisher can specify a priority for each aspect of the specifications that is used to determine an order of adjusting the aspects that optimizes the publisher's goals or preferences. For example, the publisher can lock in a specific price for the publication opportunity and specify a quality threshold can be adjustable, in response to the content submissions satisfying the specific price but not the level of interactive support, the quality threshold can be adjusted to find a suitable content submission.

At block 320, the processing device applies machine learning to generate a suitability score for each content submission of the set of content submissions in view of at least the contextual data, profile, and specifications.

At block 325, the processing device can adjust the bid for each content submission based on the suitability score of content submission.

At block 330, the processing device selects a content submission for the publication opportunity based on the on the adjusted bids, quality classification, and suitability score for the set of content submissions in view of a selection policy.

At block 335, the processing device provides content of the selected content submission to publish.

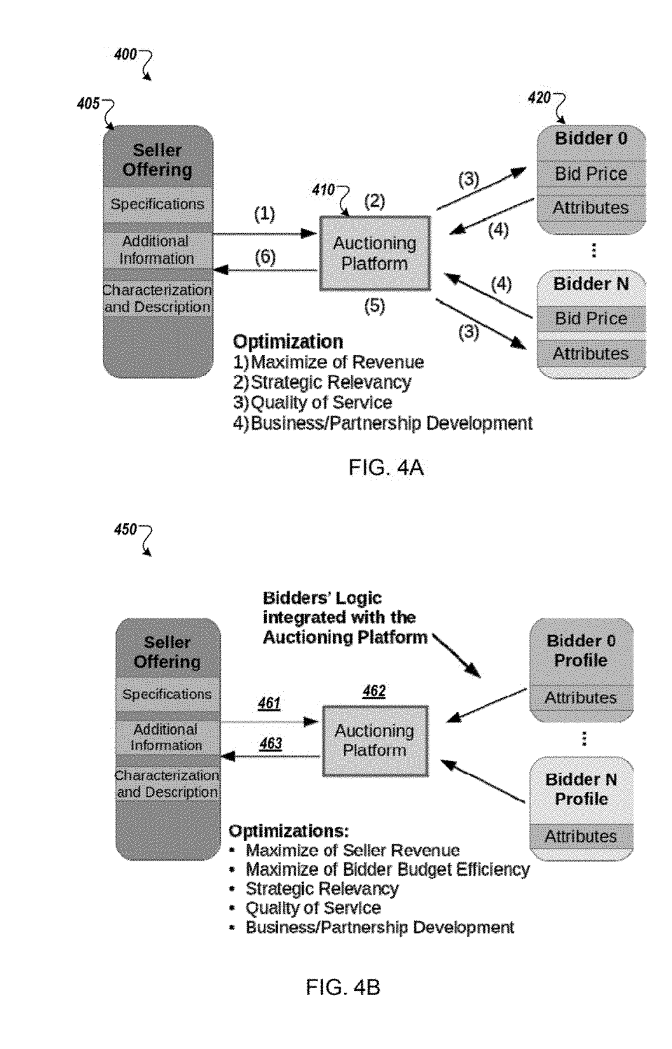

FIGS. 4A-B illustrate example transaction sequences for resource offering in accordance with example implementations.

FIG. 4A illustrates an example transaction 400 sequence for resource offering in accordance with an example implementation.

The seller offering: This entity represents the resource offering of the seller. The system considers each offering having a set of features. The first one is the specifications of the offering. The specification entries are application case specific (e.g. for advertising, specifications can include the dimensions of the space a seller provides on her website for the advertiser, the ad formats the website supports etc). The second one is the additional information, this provides additional information about the seller (e.g. for advertising, this can include the website domain or app name, the users using the website/app, etc). The third one is the “Characterization and Description” of the offering, which represents the non-structured, non-standardized description of the offering. This can be text, video, image, sound content or the output of an Artificial Intelligence/Analytics model (e.g. for advertising this can be a detailed description of the website/app, a set of descriptive terms etc.)

Bid: This entity represents the response of a bidder to a seller offering. It has 2 features. The first one is the “bid price” which represents the amount of money the bidder wills to pay for seller's offer. The second is a set of attributes which are application specific (e.g. for advertising, this should contain the advertisement content, such as video, images, text).

An auction is an atomic, transactional operation. In this example, the auction is completed in 6 steps.

1. The seller has a resource for sale, it packs a seller offering and contacts the Auctioning Platform.

2. The auction platform, receives and processes the request of step 1.

3. The auctioning platform notifies in parallel all the available bidders regarding the offering of the seller.

4. The bidder performs their internal decision making and reply back with their bids.

5. The Auctioning Platform reviews the available bids and decides on the one that wins the auction.

6. The Auctioning Platform notifies the seller with the bid that won the auction.

Note: The Auctioning platform may be a component between the seller and the bidder infrastructures but it can also be part of seller's infrastructure.

The system determines that the behavior of the auction steps can be augmented via plugins attached to hooks supported by the Auctioning Platform implementation.

In an implementation, the system is configured to optimize for the following purposes:

1. Maximize of Seller Revenue. This optimization technique extends the logic of step 2.

2. Strategic Relevancy. This optimization technique extends the logic of step 5.

3. Quality of Service. This optimization technique extends the logic of step 5.

4. Business/Partnership Development. This optimization technique extends the logic of step 4.

FIG. 4B illustrates an example of transaction sequences 450 for resource offering in accordance with an independent bidding and budgeting infrastructure.

Example implementations of transaction sequences 450 includes budget optimization for bidders. The Real-Time Auctioning Platform (e.g., Content Transaction Engine 210) does not require that that each bidder maintains its own infrastructure, analytics technology and optimization techniques in order to deploy its bidding strategies and effectively win a satisfactory number of auctions. Thus, each content provider can participate independent of maintaining an infrastructure providing high operational and development benefits that saves resources. The Auctioning Platform develops and optimizes analytics and optimization techniques for each content provider allowing advertisers to access the business intelligence to employ optimal bidding practices at reduced costs. An example aspect provides an easy-to-use, low cost, infrastructure-free and effective process for bidders to participate in auctions. Described herein is a Registry API to bidders where a bidder (i.e. content provider) can configure the following:

A description of its bidding interests in text, image, video or audio. For example, in online advertising, the advertiser (bidder) can provide a website, some text or a video presenting the characteristics of the product it wants to advertise.

The attributes that the bidder aims to include in its bids. For example, in online advertising, the content provider (advertiser, bidder, etc.) specifies the content (e.g., advertisements) it wants to use (e.g., type of media, content topic, code, etc.).

The bidder's strategies, including budget, the preferred types and characteristics of sellers. For example, in online advertising, this can be the geolocation of a website and visitor, the language used, the time of day etc.

Based on the information provided by the bidder by using the API, the system constructs a Bidder Profile. The system uses the generated Profile in order to manage all the auctioning matters for the Bidder. The system analyzes the bidding interests, attributes and strategies and optimizes auctioning to deliver auction wins under the lowest budget expenses.

FIG. 4B illustrates a transaction model according to another example implementation. As shown at 450, transaction model does not include external interfacing of the Auctioning Platform with Bidders. In this example implementation, the model 450 instead maintains a number of Bidder Profiles and the auctioning takes place internally where the Bidding Rates and Preferences are managed by Analytics. In this example implementation, the model is configured to optimize for example: Maximize of Seller Revenue, Maximize of Bidder Budget Efficiency, Strategic Relevancy both for sellers and bidders, Quality of Service both for sellers and bidders, Business/Partnership Development for sellers and bidders, etc. For example, an auctioning operation in this example implementation can be completed in 3 steps.

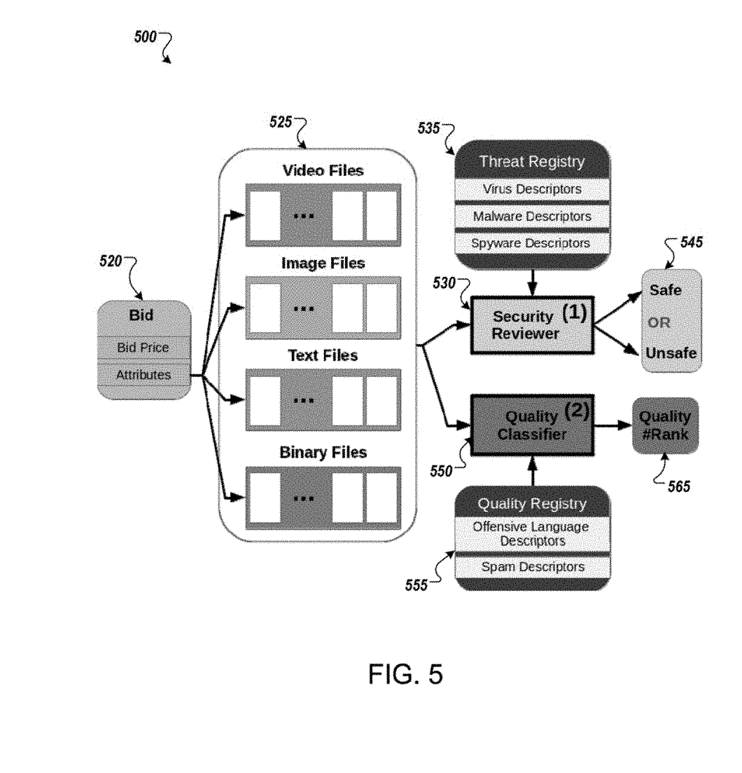

FIG. 5 illustrates an example content submission processing in accordance with an example implementation.

Quality of Service (Optimization): During a typical auctioning, a seller provides its resource offering and the bidders will to pay a price in order to purchase the resource. However, many sellers have quality of service requirements. A seller auctions a resource that is part of a larger set of resources that are still owned or controlled by the seller. The seller wants to get associated with bids that do not compromise the quality of its service ecosystem. Therefore, the system is not configured to ensure that the bidder that provides the highest financial bid automatically wins the auction. Potential compromises are any kind of virus/malware/spyware and low-quality content/activities originating from the bidder.

As an example, in Online Advertising, a website (seller) wants to only host ads that do not contain any virus/malware/spyware while they are also of high quality content which does not include any offensive language or spam.

An example aspect facilitates a content transaction service that is compatible to be applied to multiple different environments. For example, the content transaction service, as described herein, can be used for renting cloud resources to different customers (bidders).

In the example implementation, the system extracts any content type that may exist as part of Bid Attributes. The system considers a diverse group of content formats and forms including video, image, text and binary files. After the system successfully extracts all the available contents, the system employs Security Reviewer 530 and Quality Classifier 550.

The Security Reviewer 530 receives as input the content data found in each bid and it then utilizes a Threat Registry 535 to detect any potential security threat. The output of security reviewer 530 operations is the classification of each bid as Safe or Unsafe at 545. This classification employs statistical models and analytics built by using the Threat Registry 530. The Threat Registry 535 includes a description or extracted features of viruses/malware/spyware which are either stored as raw data or part of a sophisticated representation such as deep networks, embeddings or data vectors.

The Quality Classifier 550 receives as input the content data found in each bid and then utilizes a Quality Registry 555 to provide a Quality Rank 565 for the bid. The classifier 555 employs Statistical Models and Machine Learning. The output is a numerical rank 565 that represents the quality of the bid content. For example, a rank can be a single real number or a set of numbers representing multiple dimensions. The Quality Registry 555 includes descriptors of offensive language, spam, etc. For example, the descriptors may contain features, patterns and/or neural networks.

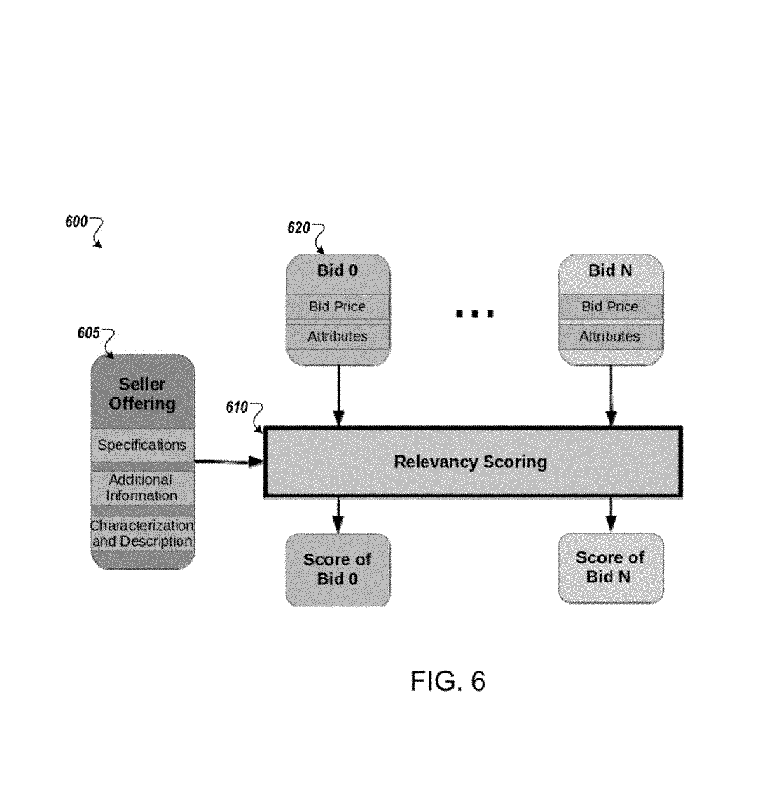

FIG. 6 illustrates an example relevancy scoring process for a transaction in accordance with an example implementation.

Strategic Relevancy (Optimization): Many sellers have strategic relevancy requirements. A seller auctions a resource that is part of a larger set of resources that are still owned or controlled by the seller. The seller ideally prefers a strong relevancy on how all the resources are utilized. As an example, in online advertising, a website (seller) rents a portion (resource) of its page to an advertiser. The website interest is to have the advertisement that appears on the website to be relevant to the content and activities of the page.

An example aspect provides an Artificial Intelligence process that contextually analyzes the available bids for a given seller offering and assigns them scores based on their contextual similarity to the seller offering. The attributes of the bids include contextual information.

Design/Technology: As show at 610, Relevancy Scoring Module receives as input the Seller Offering and all the available Bids. Relevancy Scoring Module 610 provides a relevancy score to each bid based on its relevancy to the Seller Offering. The relevancy score is used to rank and or order the available bids based on the relevancy score for each bid. The scoring and ordering may be done in single or multi-dimensional spaces. For example, Natural Language Processing, Deep Learning and standard Machine Learning techniques are employed.

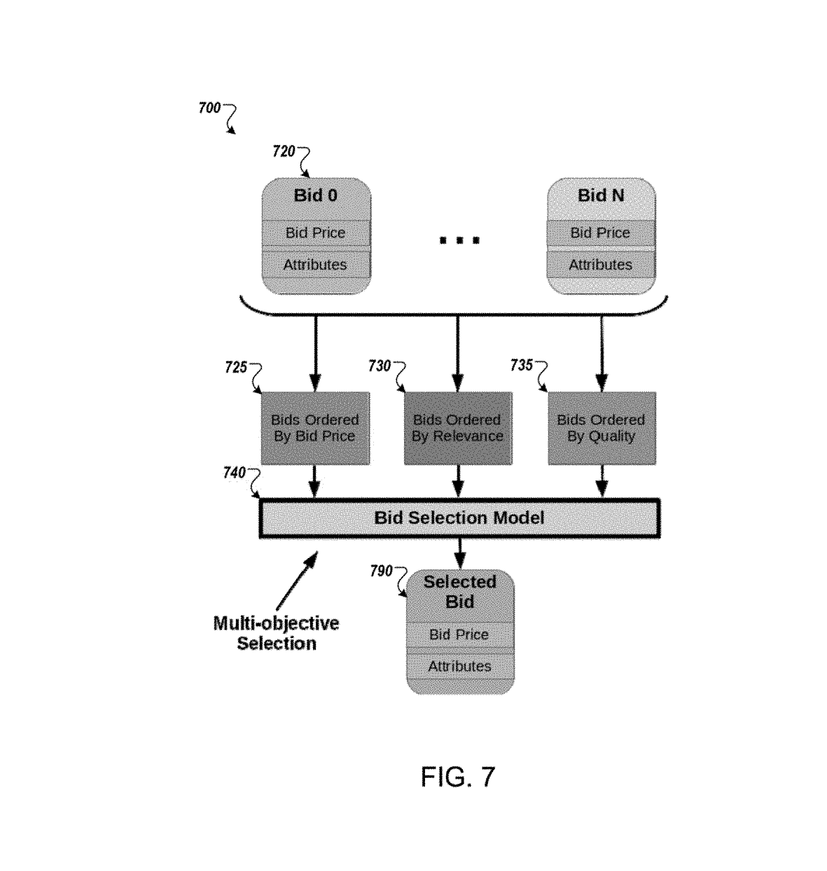

FIG. 7 illustrates an example content selection process for a transaction in accordance with an example implementation.

Multi-Objective Bid Selection Model: Real-time auctioning approach performs optimizations for multiple purposes at the same time (Optimize of Seller Revenue, Strategic Relevancy, Quality of Service, Business/Partnership Development).

Selecting the bid that satisfy all the optimizations in real-time is a non-trivial problem. The optimal bid selection lies in a multi-dimensional exploration space and its detection may be a time consuming (maybe hours or days) or a non-deterministic problem. An example aspect provides a bid selection model/mechanism that can rapidly detect either the optimal or pareto optimal set in real-time.

Design/Technology:

This selection model takes place at the step 5 of the auctioning operation and takes place only after all the optimizations have been performed.

Bids are screened that are safe and are virus/malware/spyware free.

The Business/Partnership Development optimization never gets exposed in the selection model as it takes place at the step 4 of the auctioning operation.

In an implementation, the system orders the bids based on their: Price, Relevance Score and Quality Rank and we construct 3 array lists. The system models the selected bid (e.g., as 3 Diophantine equations) where the result of the equations is the ID of the selected bid. Each equation represents the distance of the selected bid from the best one in the corresponding list category.

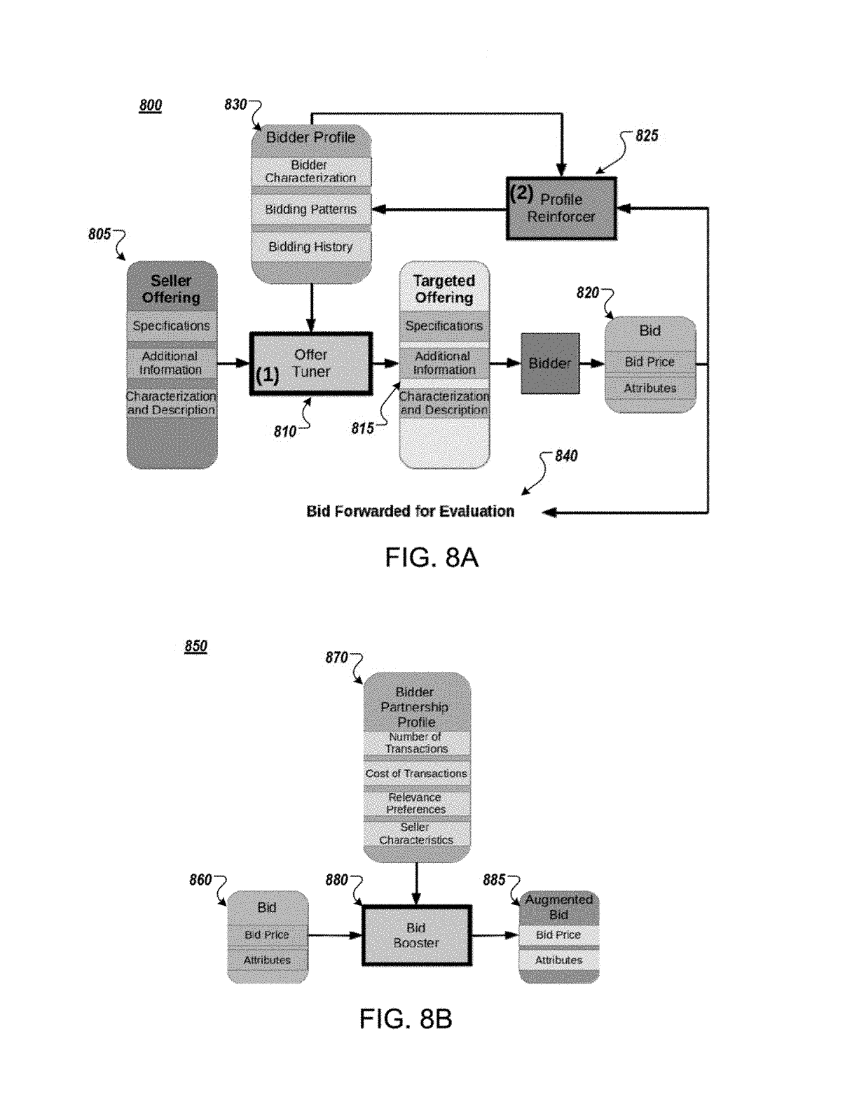

FIGS. 8A-B illustrate example implementations for optimizing resource offerings and content submissions in accordance with example implementations.

FIG. 8A illustrates example implementation 800 for optimizing resource offerings in accordance with an example implementation. FIG. 8A illustrates how the publisher offerings are optimized to make the offerings more efficient (i.e. lucrative) to the bidders while maintaining and dynamically updating profiles for the bidders. During typical auctioning, a seller provides its resource offering and the bidders will to pay a particular price in order to purchase the resource. This bid price may range between low and high levels depending how interesting/important is the seller offering to the bidder. In practice, a seller may organize/describe/present an offering in a form that does not match bidder's interest in the best possible way.

The process 800 Maximize of Publisher Revenue (Optimization): An example aspect provides an Artificial Intelligence technology that transforms seller's offerings in order to be more appealing to bidders and lead to higher bids and revenue for the seller.

Design/Technology:

The system includes the Offer Tuner and Profile Reinforcer.

The Offer Tuner (component 1) is responsible for converting/optimizing each seller offering to the characteristics of bidder on the platform. This component uses 2 inputs, the Seller Offering and the Bidder Profile. The Offer Tuner utilizes Deep Learning, Decision Trees and Reinforcement Learning in order to convert the Seller Offering to a targeted version for the particular Bidder.

The Bidder Profile provides a characterization for the bidder along with its bidding patterns and bidding history. This information can be represented as raw data, neural networks, embeddings or statistical models.

The Profile Reinforcer (component 2) is responsible to analyze the newly received bids and update the User Profile to reflect the recent behavior of the bidder. This is done by combining Neural Networks and Reinforcement Learning.

FIG. 8B illustrates an example implementation 850 for optimizing content submissions in accordance with an example implementation. FIG. 8B illustrate how a particular bidder offer can be boosted/altered to optimize particular interests without breaking the Analytics and machine-learning models.

Conventional approaches to multi-objective optimizations with simple heuristics (e.g. prioritize bid X) that favor a partnership causes damages to the overall system performance. because this approach would break/reduce the accuracy and effectiveness of the Machine Learning and statistical models. Many sellers prefer to prioritize and select less competitive bids in the favor of developing or improving partnerships with specific bidders. For example, in online advertising, a website (seller) knows that a particular advertiser (bidder) will pay the website a fixed, lucrative fee if the advertiser serves a number of advertisements on the website. In that case, the website (seller) wants to make sure that the advertiser serves at least that number of advertisements. In order to achieve that, it prioritizes that advertiser, even by ignoring higher paying bids.

Process 850 Business/Partnership Development (Optimization): An example aspect provides a mechanism that boosts specific bids to serve particular Business/Partnership interests while it also reflects the interests to the adaptive Machine Learning and statistical models that are part of the system. In an implementation, the system augment/modify bids coming from bidders of our interest (for business/partnership development purposes).

Design/Technology: The system includes Bid Booster 880. The Bid Booster 880 uses as input a Bid coming from a Bidder of interest and the Bidder Partnership Profile. The output is an “Augmented Bid” which optimizes that the bid will get prioritized on the platform while also checking to ensure that its attributes will adjust/adapt the Models to serve configured partnership interests.

For example, a Bidder Partnership Profile may provide information regarding: the Preferred Number of Transactions with the Bidder, the total Cost of Transactions, the Relevance Preferences, Particular Seller Characteristics to promote, etc.

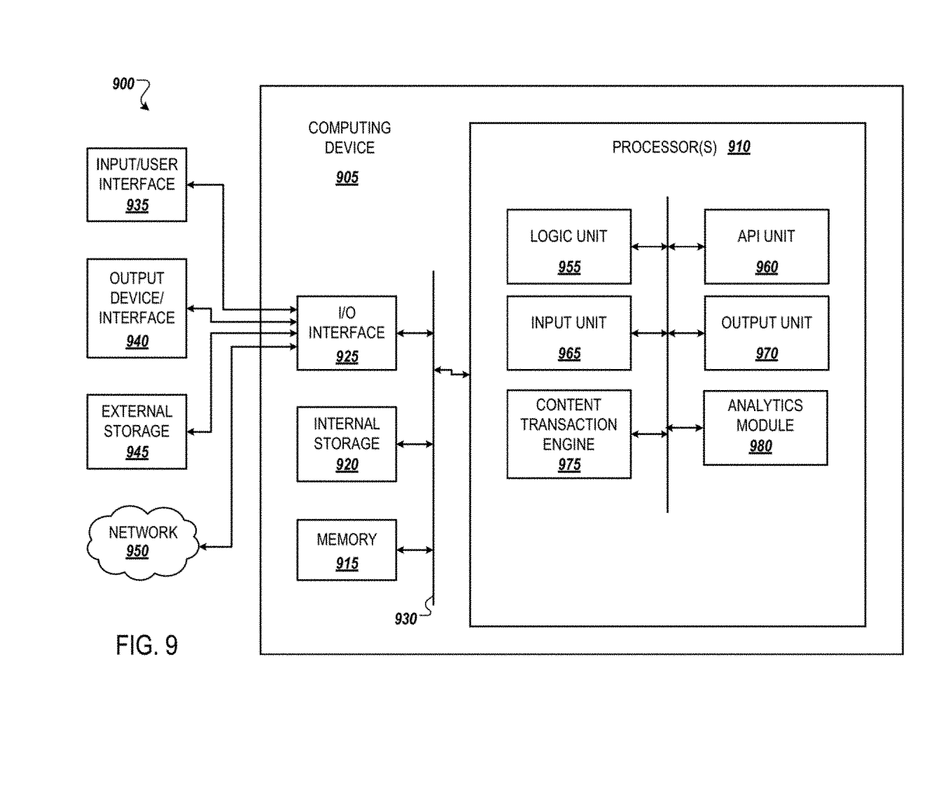

FIG. 9 shows an example computing environment with an example computing device associated with the external host for use in some example implementations. Computing device 905 in computing environment 900 can include one or more processing units, cores, or processors 910, memory 915 (e.g., RAM, ROM, and/or the like), internal storage 920 (e.g., magnetic, optical, solid state storage, and/or organic), and/or I/O interface 925, any of which can be coupled on a communication mechanism or bus 930 for communicating information or embedded in the computing device 905.

Computing device 905 can be communicatively coupled to input/user interface 935 and output device/interface 940. Either one or both of input/user interface 935 and output device/interface 940 can be a wired or wireless interface and can be detachable. Input/user interface 935 may include any device, component, sensor, or interface, physical or virtual, that can be used to provide input (e.g., buttons, touchscreen interface, keyboard, a pointing/cursor control, microphone, camera, braille, motion sensor, optical reader, and/or the like).

Output device/interface 940 may include a display, television, monitor, printer, speaker, braille, or the like. In some example implementations, input/user interface 935 and output device/interface 940 can be embedded with or physically coupled to the computing device 905. In other example implementations, other computing devices may function as or provide the functions of input/user interface 935 and output device/interface 940 for a computing device 905.

Examples of computing device 905 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computing device 905 can be communicatively coupled (e.g., via I/O interface 925) to external storage 945 and network 950 for communicating with any number of networked components, devices, and systems, including one or more computing devices of the same or different configuration. Computing device 905 or any connected computing device can be functioning as, providing services of, or referred to as a server, client, thin server, general machine, special-purpose machine, or another label.

The I/O interface 925 may include wireless communication components (not shown) that facilitate wireless communication over a voice and/or over a data network. The wireless communication components may include an antenna system with one or more antennae, a radio system, a baseband system, or any combination thereof. Radio frequency (RF) signals may be transmitted and received over the air by the antenna system under the management of the radio system.

I/O interface 925 can include, but is not limited to, wired and/or wireless interfaces using any communication or I/O protocols or standards (e.g., Ethernet, 802.11x, Universal System Bus, WiMax, modem, a cellular network protocol, and the like) for communicating information to and/or from at least all the connected components, devices, and network in computing environment 900. Network 950 can be any network or combination of networks (e.g., the Internet, local area network, wide area network, a telephonic network, a cellular network, satellite network, and the like).

Computing device 905 can use and/or communicate using computer-usable or computer-readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid state media (e.g., RAM, ROM, flash memory, solid-state storage), and other non-volatile storage or memory.

Computing device 905 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C#, Java, Visual Basic, Python, Perl, JavaScript, and others).

Processor(s) 910 can execute under any operating system (OS) (not shown), in a native or virtual environment. One or more applications can be deployed that include logic unit 955, application programming interface (API) unit 960, input unit 965, output unit 970, content transaction engine 975, and analytics module 980. For example, input unit 965, content transaction engine 975, and analytics module 980, may implement one or more processes shown in FIGS. 1-2. The described units and elements can be varied in design, function, configuration, or implementation and are not limited to the descriptions provided.

In some example implementations, the analytics module 980 operates on a client device such as 125a-125n of FIG. 1 In some example implementations, when information or an execution instruction is received by API unit 960, it may be communicated to one or more other units (e.g., logic unit 955, output unit 970, input unit 965, content transaction engine 975, and analytics module 980).

Input unit 965 may, via API unit 960, interact with the content transaction engine 975, and analytics module 980, to provide the input information. Using API unit 960, content transaction engine 975, and analytics module 980, the system can analyze the information to provide transaction support to publishes and content providers, for example.

In some instances, logic unit 955 may be configured to control the information flow among the units and direct the services provided by API unit 960, input unit 965, output unit 970, input unit 965, content transaction engine 975, and analytics module 980, in some example implementations described above. For example, the flow of one or more processes or implementations may be controlled by logic unit 955 alone or in conjunction with API unit 960.

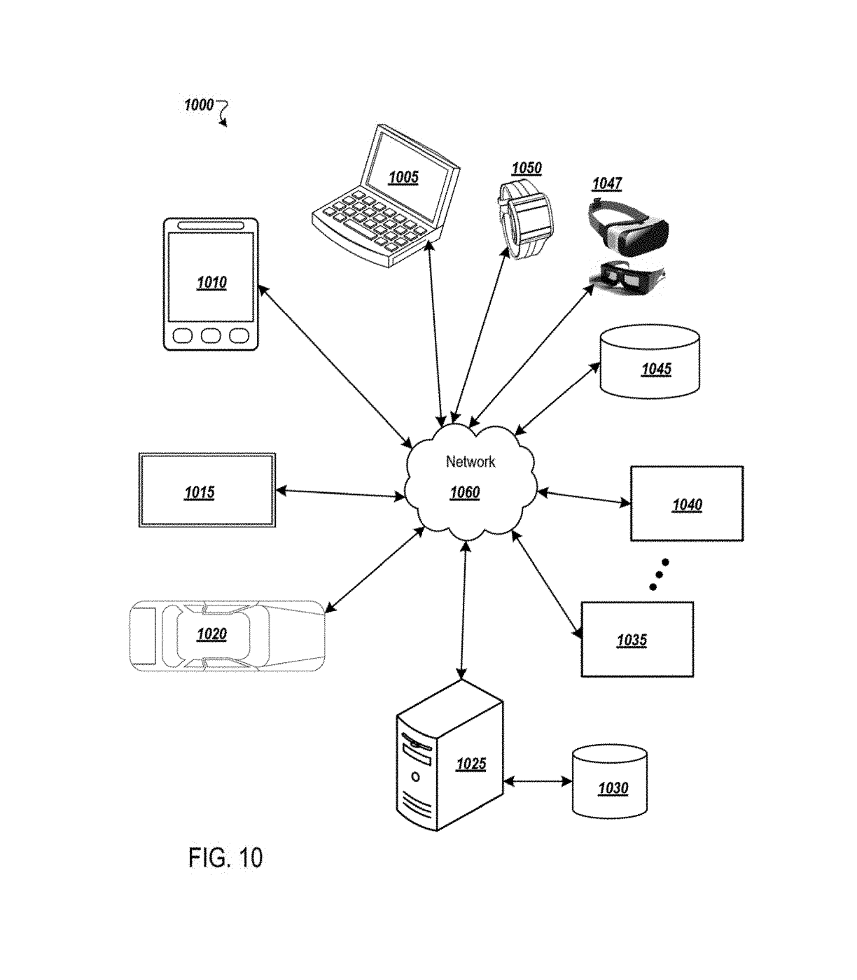

FIG. 10 shows an example environment suitable for some example implementations. Environment 1000 includes devices 1005-1050, and each is communicatively connected to at least one other device via, for example, network 1060 (e.g., by wired and/or wireless connections). Some devices may be communicatively connected to one or more storage devices 1030 and 1045.

An example of one or more devices 1005-1050 may be computing devices 905 described in regards to FIG. 9, respectively. Devices 1005-1050 may include, but are not limited to, a computer 1005 (e.g., a laptop computing device) having a display and as associated webcam as explained above, a mobile device 1010 (e.g., smartphone or tablet), a television 1015, a device associated with a vehicle 1020, a server computer 1025, computing devices 1035-1040, storage devices 1030 and 1045, augments reality and virtual reality devices 1047. As explained above, the meeting environment of the user may vary, and is not limited to an office environment.

In some implementations, devices 1005-1020, 1050 may be considered user devices associated with the users of the enterprise. Devices 1025-1050 may be devices associated with client service (e.g., used by the users or administrators to provide transaction services as described above and with respect to FIGS. 1-8, and/or store data, such as, webpages, text, text portions, images, image portions, audios, audio segments, videos, video segments, and/or information thereabout).

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined operations leading to a desired end state or result. In example implementations, the operations carried out uses physical manipulations of tangible quantities for achieving a tangible result.

Unless specifically stated otherwise, as apparent from the discussion, it is appreciated that throughout the description, discussions utilizing terms such as “receiving,” “applying” “determining,” “gathering,” “generating,” “processing,” “performing,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the prescribed purposes, or it may include one or more general-purpose computers selectively activated or reconfigured by one or more computer programs. Such computer programs may be stored in a computer readable medium, such as a computer-readable storage medium or a computer-readable signal medium.

A computer-readable storage medium may involve tangible mediums such as, but not limited to optical disks, magnetic disks, read-only memories, random access memories, solid state devices and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method operations. In addition, the example implementations are not described with reference to any particular programming language. It will be appreciated that a variety of programming languages may be used to implement the teachings of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application.

Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general-purpose computer, based on instructions stored on a computer-readable medium. If desired, the instructions can be stored on the medium in a compressed and/or encrypted format.

The example implementations may have various differences and advantages over related art. For example, but not by way of limitation, as opposed to instrumenting web pages with JavaScript as explained above with respect to the related art, text and mouse (e.g., pointing) actions may be detected and analyzed in video documents.

Moreover, other implementations of the present application will be apparent to those skilled in the art from consideration of the specification and practice of the teachings of the present application. Various aspects and/or components of the described example implementations may be used singly or in any combination. It is intended that the specification and example implementations be considered as examples only, with the true scope and spirit of the present application being indicated by the following claims.

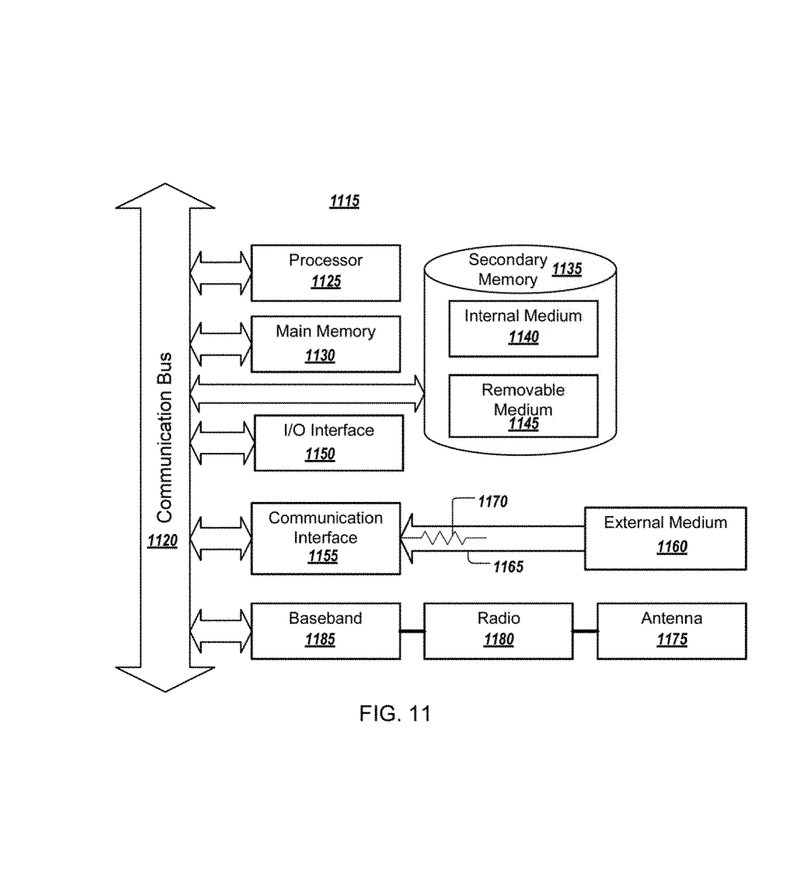

FIG. 11 provides a block diagram illustrating an example computing device or system that may be used in connection with various example implementations described herein. For example the system 1105 may be used as or in conjunction with one or more of the mechanisms or processes described above, and may represent components of processors, user system(s), and/or other devices described herein. The system 1105 can be a server or any conventional personal computer, or any other processor-enabled device that is capable of wired or wireless data communication. Other computer systems and/or architectures may be also used, as will be clear to those skilled in the art.

The system 1105 preferably includes one or more processors, such as processor 1115. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 1115. Examples of processors which may be used with system 1105 include, without limitation, the Pentium® processor, Core i7® processor, and Xeon® processor, all of which are available from Intel Corporation of Santa Clara, Calif.

The processor 1115 is preferably connected to a communication bus 1110. The communication bus 1110 may include a data channel for facilitating information transfer between storage and other peripheral components of the system 1110. The communication bus 1110 further may provide a set of signals used for communication with the processor 1115, including a data bus, address bus, and control bus (not shown). The communication bus 1110 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, or standards promulgated by the Institute of Electrical and Electronics Engineers (IEEE) including IEEE 1188 general-purpose interface bus (GPIB), IEEE 696/S-30, and the like.

System 1105 preferably includes a main memory 1120 and may also include a secondary memory 1125. The main memory 1120 provides storage of instructions and data for programs executing on the processor 1115, such as one or more of the functions and/or modules discussed above. It should be understood that programs stored in the memory and executed by processor 1115 may be written and/or compiled according to any suitable language, including without limitation C/C++, Java, JavaScript, Pearl, Visual Basic, .NET, and the like. The main memory 1120 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

The secondary memory 1125 may optionally include an internal memory 1130 and/or a removable medium 1135, for example a floppy disk drive, a magnetic tape drive, a compact disc (CD) drive, a digital versatile disc (DVD) drive, other optical drive, a flash memory drive, etc. The removable medium 1135 is read from and/or written to in a well-known manner. Removable storage medium 1135 may be, for example, a floppy disk, magnetic tape, CD, DVD, SD card, etc.

The removable storage medium 1135 is a non-transitory computer-readable medium having stored thereon computer executable code (i.e., software) and/or data. The computer software or data stored on the removable storage medium 1135 is read into the system 1105 for execution by the processor 1115.

In alternative example implementations, secondary memory 1125 may include other similar means for allowing computer programs or other data or instructions to be loaded into the system 1105. Such means may include, for example, an external storage medium 1150 and an interface 1145. Examples of external storage medium 1150 may include an external hard disk drive or an external optical drive, or and external magneto-optical drive.

Other examples of secondary memory 1125 may include semiconductor-based memory such as programmable read-only memory (PROM), erasable programmable read-only memory (EPROM), electrically erasable read-only memory (EEPROM), or flash memory (block oriented memory similar to EEPROM). Also included are any other removable storage media 1135 and communication interface 1145, which allow software and data to be transferred from an external medium 1150 to the system 1105.

System 1105 may include a communication interface 1145. The communication interface 1145 allows software and data to be transferred between system 1105 and external devices (e.g. printers), networks, or information sources. For example, computer software or executable code may be transferred to system 1105 from a network server via communication interface 1145. Examples of communication interface 1145 include a built-in network adapter, network interface card (NIC), Personal Computer Memory Card International Association (PCMCIA) network card, card bus network adapter, wireless network adapter, Universal Serial Bus (USB) network adapter, modem, a network interface card (NIC), a wireless data card, a communications port, an infrared interface, an IEEE 1394 fire-wire, or any other device capable of interfacing system 1105 with a network or another computing device.

Communication interface 1145 preferably implements industry promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software and data transferred via communication interface 1145 are generally in the form of electrical communication signals 1160. These signals 1160 are preferably provided to communication interface 1145 via a communication channel 1155. In one example implementation, the communication channel 1155 may be a wired or wireless network, or any variety of other communication links. Communication channel 1155 carries signals 1160 and can be implemented using a variety of wired or wireless communication means including wire or cable, fiber optics, conventional phone line, cellular phone link, wireless data communication link, radio frequency (“RF”) link, or infrared link, just to name a few.

Computer executable code (i.e., computer programs or software) is stored in the main memory 1120 and/or the secondary memory 1125. Computer programs can also be received via communication interface 1145 and stored in the main memory 1120 and/or the secondary memory 1125. Such computer programs, when executed, enable the system 1105 to perform the various functions of the present invention as previously described.

In this description, the term “computer readable medium” is used to refer to any non-transitory computer readable storage media used to provide computer executable code (e.g., software and computer programs) to the system 1105. Examples of these media include main memory 1120, secondary memory 1125 (including internal memory 1130, removable medium 1135, and external storage medium 1150), and any peripheral device communicatively coupled with communication interface 1145 (including a network information server or other network device). These non-transitory computer readable mediums are means for providing executable code, programming instructions, and software to the system 1105.

In an example implementation that is implemented using software, the software may be stored on a computer readable medium and loaded into the system 1105 by way of removable medium 1135, I/O interface 1140, or communication interface 1145. In such an example implementation, the software is loaded into the system 1105 in the form of electrical communication signals 1160. The software, when executed by the processor 1115, preferably causes the processor 1115 to perform the inventive features and functions previously described herein.

In an example implementation, I/O interface 1140 provides an interface between one or more components of system 1105 and one or more input and/or output devices. Example input devices include, without limitation, keyboards, touch screens or other touch-sensitive devices, biometric sensing devices, computer mice, trackballs, pen-based pointing devices, and the like. Examples of output devices include, without limitation, cathode ray tubes (CRTs), plasma displays, light-emitting diode (LED) displays, liquid crystal displays (LCDs), printers, vacuum florescent displays (VFDs), surface-conduction electron-emitter displays (SEDs), field emission displays (FEDs), and the like.

The system 1105 also includes optional wireless communication components that facilitate wireless communication over a voice and over a data network. The wireless communication components comprise an antenna system 1165, a radio system 1170, and a baseband system 1175. In the system 1105, radio frequency (RF) signals are transmitted and received over the air by the antenna system 1165 under the management of the radio system 1170.

In one example implementation, the antenna system 1165 may comprise one or more antennae and one or more multiplexors (not shown) that perform a switching function to provide the antenna system 1165 with transmit and receive signal paths. In the receive path, received RF signals can be coupled from a multiplexor to a low noise amplifier (not shown) that amplifies the received RF signal and sends the amplified signal to the radio system 1170.

In alternative example implementations, the radio system 1170 may comprise one or more radios that are configured to communicate over various frequencies. In one example implementation, the radio system 1170 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from the radio system 1170 to the baseband system 1175.

If the received signal contains audio information, then baseband system 1175 decodes the signal and converts it to an analog signal. Then the signal is amplified and sent to a speaker. The baseband system 1175 also receives analog audio signals from a microphone. These analog audio signals are converted to digital signals and encoded by the baseband system 1175. The baseband system 1175 also codes the digital signals for transmission and generates a baseband transmit audio signal that is routed to the modulator portion of the radio system 1170. The modulator mixes the baseband transmit audio signal with an RF carrier signal generating an RF transmit signal that is routed to the antenna system and may pass through a power amplifier (not shown). The power amplifier amplifies the RF transmit signal and routes it to the antenna system 1165 where the signal is switched to the antenna port for transmission.

The baseband system 1175 is also communicatively coupled with the processor 1115. The central processing unit 1115 has access to data storage areas 1120 and 1125. The central processing unit 1115 is preferably configured to execute instructions (i.e., computer programs or software) that can be stored in the memory 1120 or the secondary memory 1125. Computer programs can also be received from the baseband processor 1165 and stored in the data storage area 1120 or in secondary memory 1125, or executed upon receipt. Such computer programs, when executed, enable the system 1105 to perform the various functions of the present invention as previously described. For example, data storage areas 1120 may include various software modules (not shown).

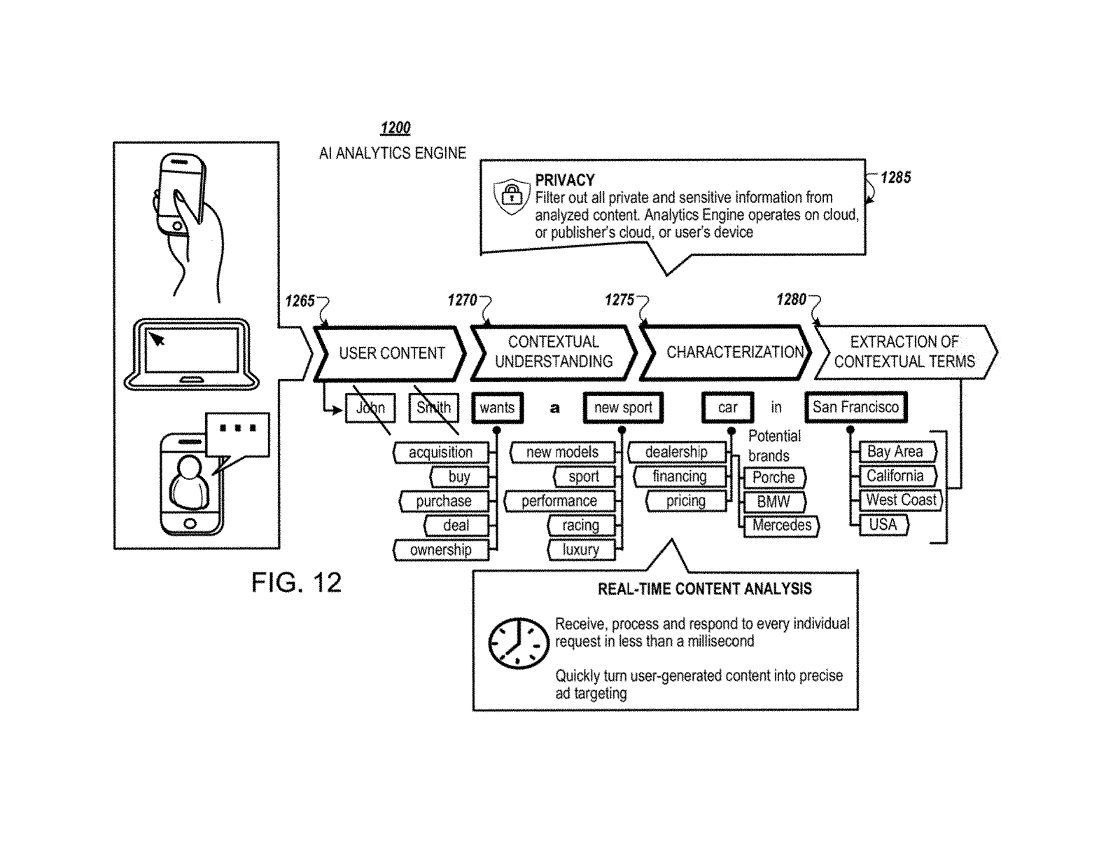

FIG. 12 illustrates an example analytics flow diagram 1200 in accordance with an example implementation. The analytics flow diagram 1200 can include receiving content submissions that are processed by an analytics engine (e.g., real-time runtime artificial intelligence system 230 of FIG. 2) to contextualize, characterize, and extract contextual terms as described herein.

The analytics flow diagram 1200 includes a high-level presentation of the functionality of the analytics engine. The analytics engine can receive supplemental content for the content submissions from the content providers via a portal, API, or device (e.g. laptop, mobile device, etc.), filters out sensitive content that is malicious or low quality, performs quality categorization and contextual analyses. The analytics engine uses the results to characterize the content by using generic terms. In an example, the output of the analytics engine for the phrase “John Smith wants a new sport car in San Francisco” extracts context terms as shown.

The analytics engine uses machine learning techniques and artificial intelligence driven technology to operate as a characterization and recommendation system for supplemental content. According to an example implementation, characterization and recommendation system operates without prior knowledge about the content or its origin.

While certain embodiments have been described above, it will be understood that the embodiments described are by way of example only. Accordingly, the systems and methods described herein should not be limited based on the described embodiments. Rather, the systems and methods described herein should only be limited in light of the claims that follow when taken in conjunction with the above description and accompanying drawings.

What is claimed is:

1. A system for data processing comprising:
a memory;
one or more processors coupled to the memory, wherein the processor is to:
receive a plurality of content submissions for a publication opportunity, wherein each content submission comprises a bid with one or more attributes and is associated with a profile, and wherein the publication opportunity comprises specifications;
analyze each of the content submissions to determine a quality classification and contextual data based at least on the attributes of the content submission;
determine a set of content submissions that satisfy the specifications in view of the quality classification and contextual data;
apply a targeting framework to the publication opportunity based on the bids of the set of content submissions, wherein the specifications of the publication opportunity are adjustable;
apply machine learning to generate a suitability score for each content submission of the set of content submissions in view of at least the contextual data, profile, and specifications;
adjust the bid for each content submission based on the suitability score of content submission;
select a content submission for the publication opportunity based on the on the adjusted bids, quality classification, and suitability score for the set of content submissions in view of a selection policy; and
provide content of the selected content submission to publish.

2. A method for data processing comprising:
receiving a plurality of content submissions for a publication opportunity, wherein each content submission comprises a bid with one or more attributes and is associated with a profile, and wherein the publication opportunity comprises specifications;
analyzing each of the content submissions to determine a quality classification and contextual data based at least on the attributes of the content submission;
determining a set of content submissions from the plurality of content submissions that satisfy the specifications in view of the quality classification and contextual data;
applying a targeting framework to the publication opportunity based on the bids of the set of content submissions, wherein the specifications of the publication opportunity are adjustable;
applying machine learning to generate a suitability score for each content submission of the set of content submissions in view of at least the contextual data and profile associated with the content submission, and specifications;
adjust the bid for each content submission based on the suitability score of content submissions of the publication opportunity;
selecting a content submission for the publication opportunity based on the on the adjusted bids, quality classification, and suitability score for the set of content submissions in view of a selection policy, wherein content of the selected content submission is published.
